(19) United States
(12) Patent Application Publication
(10) Pub. No.: US 2026/0247498 A1
(43) Pub. Date: Aug. 20, 2026

(54) HEATER ROD

(71) Applicant: BorgWarner Inc., Auburn Hills, MI (US)

(72) Inventors: Matías Baleato Peon, Vigo (ES); Jose Alberto Blanco Fernandez, Gondomar (ES)

(21) Appl. No.: 19/532,205

(22) Filed: Feb. 6, 2026

(30) Foreign Application Priority Data
Feb. 19, 2025 (EP) 25 158 727.5

(51) Int. Cl. H05B 3/50; H05B 3/14

(52) U.S. Cl. CPC H05B 3/50; H05B 3/141; H05B 2203/017

(57) ABSTRACT

Disclosed is a heater rod including a tube housing, a ceramic heating resistor, a contact sheet electrically contacting the heating resistor, and a dielectric electrically isolating the contact sheet from the tube housing. The tube housing is formed by two half-shells, each half-shell having opposing lateral sections and a main section connecting the lateral sections. On opposite sides of the tube housing, a part of the lateral section of one of the two half-shells is on the inside of the tube housing and a part of the lateral section of the other half-shell is on the outside of the tube housing. Also disclosed is a method for manufacturing a heater rod. 5175981

### RELATED APPLICATIONS

This application claims priority to European Patent Application No. 25 158 727.5, filed Feb. 19, 2025, the entire disclosure of which is hereby incorporated herein by reference.

### BACKGROUND

This disclosure relates to a heater rod of the type generally described in EP 2 393 336 A1.

Such heater rods are used in vehicle heaters for heating air that is blown into the vehicle cabin. The housing of such heater rods protects one or more heating resistors from ambient influences, especially moisture and dirt, and has to ensure good thermal coupling to the heating resistors so that heat produced by the resistors can be transmitted effectively to an ambient fluid, especially air.

EP 2 393 336 A1 discloses several heater rods. One of the heater rods has a housing that comprises two half-shells forming a flange where they are connected by means of an adhesive. Another heater rod disclosed in EP 2 393 336 A1 comprises a tubular housing produced as a single piece by extrusion.

Constant goals in the development of heater rods are low production costs and good thermal conduction from the heating resistor(s) to the outside of the housing.

### SUMMARY

This disclosure teaches a heater rod that shows how the above-stated goals can be achieved to an even larger extent.

The heater rod of this disclosure comprises a housing formed by two half-shells. On opposing sides of the tube housing, a part of the lateral section of one of the two half-shells is on the inside of the tube housing and a part of the lateral section of the other half-shell is on the outside of the tube housing. During assembly a stack comprising a ceramic heating element, a contact sheet and a dielectric is arranged in a first half-shell and then a second half-shell is placed on top of the stack. As there is no flange on which the second half-shell abuts, both half-shells abut on the stack. Thereby, good thermal contact is ensured without the need to manufacture either the stack or the half-shells to narrow tolerances. Moreover, there is no need to plastically deform the half-shells by compressing the tube housing in order to ensure good thermal contact. Thereby, a risk of breaking the ceramic heating elements can be avoided and manufacturing output improved.

According to this disclosure, the method for manufacturing a heater rod comprises the steps of arranging a stack of a ceramic heating element, a contact sheet and a dielectric in a first half-shell, arranging a second half-shell on top of the stack such that lateral sections of the two half-shells overlap in an overlap area facing a lateral side of the stack, and joining the half-shells in the overlap area, e.g., by welding. The overlap area is the area in which the lateral sections of the half-shells contact each other. Thus, the overlap area extends in a longitudinal direction of the heater rod and in the stacking direction of the stack formed of the dielectric, the contact sheets, and the ceramic heating resistor.

In an advantageous refinement of this disclosure, both half-shells are equal, i.e., do not differ by more than manufacturing tolerances. This simplifies manufacturing, but it is also possible to use different half-shells, e.g., a larger half-shell and a smaller half-shell enclosed on both lateral sections by the larger half-shell.

### BRIEF DESCRIPTION OF THE DRAWINGS

The above-mentioned aspects of exemplary embodiments will become more apparent and will be better understood by reference to the following description of the embodiments taken in conjunction with the accompanying drawings, wherein:

FIG. 1 shows an embodiment of a heating rod; and

FIG. 2 shows a cross-section of the heating rod shown in FIG. 1.

### DESCRIPTION

The embodiments described below are not intended to be exhaustive or to limit the invention to the precise forms disclosed in the following description. Rather, the embodiments are chosen and described so that others skilled in the art may appreciate and understand the principles and practices of this disclosure.

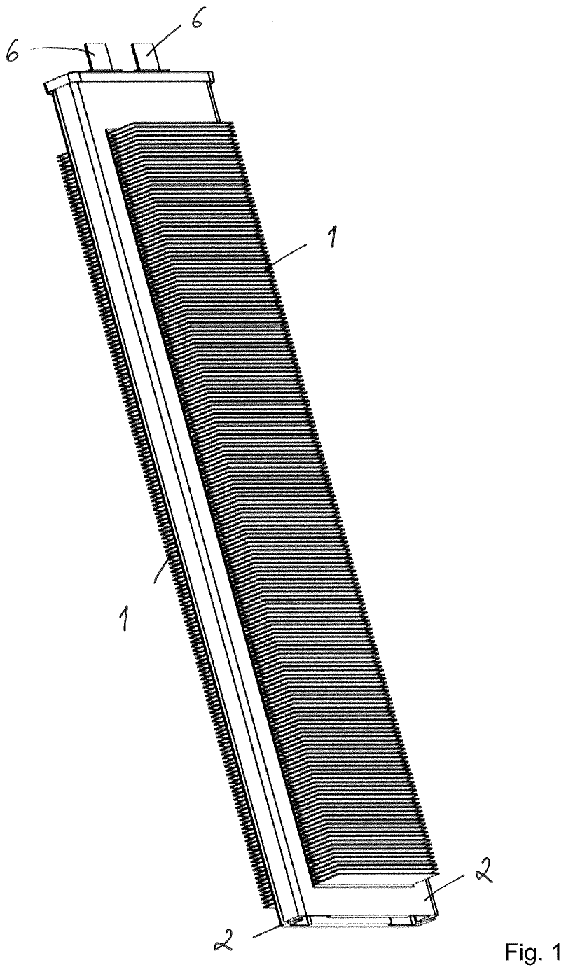

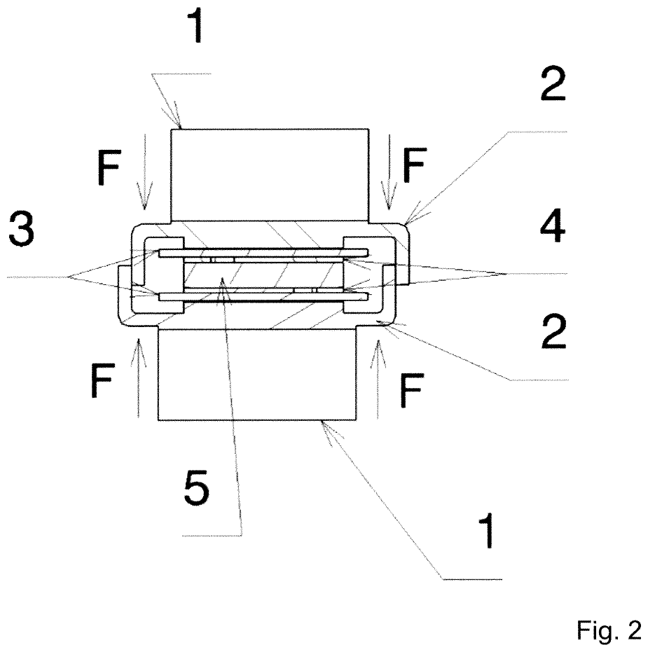

The heating rod shown in FIGS. 1 and 2 comprises a tube housing forming a flat tube. The tube housing is formed by two half-shells 2 and encloses one or more ceramic heating resistors 5, two contact sheets 4 electrically contacting the ceramic heating resistor(s) 5 on opposite sides, and dielectrics 3, e.g., sheets of alumina, that electrically isolate the contact sheets 4 from the housing. In low voltage applications, one of the half-shells 2 may be used as a ground contact to the ceramic heating resistor(s) 5 such that one of the contact sheets 4 and the corresponding dielectric 3 may then be removed. Terminals 6 may be provided by a narrow section of the contact sheets 2 or be separate parts.

The half-shells 2 each comprise opposing lateral sections and a main section connecting the lateral sections. The lateral sections form the narrow sides of the flat tube. The broad sides of the flat tube are formed by the main sections of the half-shells 2. The main section may be provided with fins 1.

As shown in FIG. 1, a part of the lateral section of one of the half-shells 2 is on the inside of the tube housing and a part of the lateral section of the half-shells 2 is on the outside of the tube housing. In FIG. 1, the lateral section on the left of the lower half-shell 2 is on the outside and the lateral section on the left of the upper half-shell 2 is on the inside of the tube housing. If both half-shells 2 are equal, as shown in FIG. 1, the situation on the right side is reversed; that is the lateral section on the right of the lower half-shell 2 is on the inside and the lateral section on the right of the upper half-shell 2 is on the outside. It is also possible to use different half-shells, especially a larger and a smaller half-shell. Then both lateral sections of one half-shells might be on the inside and both lateral half-shells of the other half-shell might be on the outside.

During assembly of the heater rod, a stack comprising a dielectric 3, e.g., a sheet of electrically isolating ceramic or plastic, a contact sheet 4, one or more ceramic heating resistors 5, a second contact sheet 4 and second dielectric 3 is arranged inside a first half-shell 2. The stacking direction of this stack points to the main section of the first half-shell 2. If the stack comprises a plurality of heating resistors 5, they may be arranged in a row forming a layer of the stack.

Then the second half-shell 2 is placed on top of the stack. On both lateral sides of the tube housing, a part of the lateral section of one of the half-shells 2 is then on the inside of the tube housing and a part of the lateral section of the half-shells is on the outside of the tube housing. Then the two half-shells 2 are joined in the overlap area by welding. In order to ensure good thermal contact of the half-shells 2 to the stack, both half-shells 2 may be pressed with a force F against the stack during the welding process. The force F then acts in the stacking direction of the stack.

As can be seen in FIG. 1, the two half-shells 2 overlap in an overlap area facing a lateral side of the stack. The overlap area is the area in which the lateral sections of the half-shells 2 contact each other. The overlap area extends in a longitudinal direction of the heater rod and in the stacking direction of the stack formed of the dielectric 3, the contact sheets 4, and the ceramic heating resistor 5. In the embodiment shown in FIG. 1, the lateral sections of the half-shells 2 extend straight and perpendicular to the main section. The distal ends of the lateral sections of the half-shells point in the stacking direction of the stack.

The fins 1 on the half-shells 2 may be provided by skiving or provided separately and attached to the half-shells 2, e.g., by welding or an adhesive. In the embodiment shown, the fins 1 extend only over a part of the width of the half-shells 2. Thus, on both sides of the fins 1 there is strip shaped section that extends along the entire length of the half-shells 1 and is free of fins 1. As shown in FIG. 2, the main section of each half-shell 2 has a width that is smaller than a dimension of the fins 1, said dimension extending in the direction of the width of the main section.

The ceramic heating resistors 5 may, for example, be PTC resistors, e.g., on the basis of barium titanate. The half-shells 2 may be made of metal, e.g., an aluminum-based alloy.

While exemplary embodiments have been disclosed hereinabove, the present invention is not limited to the disclosed embodiments. Instead, this application is intended to cover any variations, uses, or adaptations of this disclosure using its general principles. Further, this application is intended to cover such departures from the present disclosure as come within known or customary practice in the art to which this invention pertains and which fall within the limits of the appended claims.

### LIST OF REFERENCE SYMBOLS

1 fins
2 half-shells
3 dielectric
4 contact sheets
5 heating resistor
6 terminals
F force

What is claimed is:

1. A heater rod, comprising:
a tube housing;
a ceramic heating resistor;
a contact sheet electrically contacting the heating resistor; and
a dielectric electrically isolating the contact sheet from the tube housing;
wherein the tube housing is formed by two half-shells, each half-shell comprising opposing lateral sections and a main section connecting the lateral sections;
wherein on opposite sides of the tube housing, a part of the lateral section of one of the two half-shells is on the inside of the tube housing and a part of the lateral section of the other half-shell is on the outside of the tube housing.

2. The heater rod according to claim 1, wherein the two half-shells are welded to each other in the overlap area.

3. The heater rod according to claim 1, wherein the two half-shells are equal.

4. The heater rod according to claim 1, wherein the half-shells are provided with fins on their main section.

5. The heater rod according to claim 1, wherein the main section of each half-shell has a width that is smaller than a dimension of the fins, said dimension extending in the direction of the width of the main section.

6. The heater rod according to claim 1, wherein the heating resistor is electrically contacted by two contact sheets arranged on opposing sides.

7. The heater rod according to claim 1, wherein the half-shells have an increased thickness in a central region of the main section.

8. The heater rod according to claim 1, wherein the tube housing forms a flat tube.

9. A method for manufacturing a heater rod, comprising:
arranging a stack of a ceramic heating element, a contact sheet and a dielectric in a first half-shell;
arranging a second half-shell on top of the stack such that lateral sections of the two half-shells overlap in an overlap area facing a lateral side of the stack; and
joining the half-shells in the overlap area.

10. The method according to claim 9, wherein the half-shells are joined in the overlap area by welding.

11. The method according to claim 9, wherein the half-shells are provided with fins by skiving.

12. The method according to claim 9, wherein the half-shells are pressed against the stack while they are joined in the overlap area.
